(19) United States
(12) Patent Application Publication
(10) Pub. No.: US 2021/0248587 A1
(43) Pub. Date: Aug. 12, 2021

(54) METHODS AND SYSTEMS FOR ANONYMOUS AND EFFICIENT ELECTRONIC TRANSACTIONS

(71) Applicant: Lesly Jean-Paul, Boston, MA (US)

(72) Inventor: Lesly Jean-Paul, Boston, MA (US)

(73) Assignee: Lesly Jean-Paul, Boston, MA (US)

(21) Appl. No.: 17/170,800

(22) Filed: Feb. 8, 2021

Related U.S. Application Data
(60) Provisional application No. 62/971,879, filed on Feb. 7, 2020.

(51) Int. Cl. G06Q 20/32; G06Q 20/02; G06Q 20/10; G06Q 20/38

(52) U.S. Cl. CPC G06Q 20/3274; G06Q 20/023; G06Q 20/3276; G06Q 20/383; G06Q 20/385; G06Q 20/108

(57) ABSTRACT

Described herein are systems for anonymous payments. The systems receive an input corresponding to an amount of funds to be transferred from a first account to a second account. The systems further generates a code corresponding to the amount of funds to be transferred from the first account to the second account. The systems further display the code on a screen of a processing device, and receive an indication that the funds have been transferred from the first account to the second account. The systems further display on the screen an indication that the code has been redeemed, and that funds have been transferred from the first account to the second account.

### TECHNICAL FIELD

The present disclosure relates to techniques for anonymously and efficiently completing electronic transactions between entities. More specifically, the present disclosure relates to methodologies, systems and devices for anonymously transmitting information between two financial database entries.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1 is an exemplary flow diagram of an exemplary system for making anonymous payments, according to embodiments of the present disclosure.

FIG. 2 is an exemplary flow diagram of an exemplary system for making anonymous payments using a unique QRCode, according to embodiments of the present disclosure.

FIG. 3 is an exemplary flow diagram of an exemplary system for making anonymous payments using a unique QRCode, according to embodiments of the present disclosure.

FIG. 4 is an exemplary flow diagram of an exemplary system for generating unique QRCodes, in accordance with exemplary embodiments of the present disclosure.

FIG. 5 is an exemplary flow diagram of an exemplary system for generating unique QRCodes, in accordance with exemplary embodiments of the present disclosure.

FIG. 6 is an exemplary flow diagram of transferring a unique QRCode from a cloud storage device to a bank account, in accordance with exemplary embodiments of the present disclosure.

FIG. 7 is an exemplary flow diagram of a unique QRCode being scanned by a scanning device, in accordance with exemplary embodiments of the present disclosure.

FIG. 8 is an exemplary user interface for generating anonymous payment transactions using a unique QRCode, in accordance with exemplary embodiments of the present disclosure.

FIG. 9 is an exemplary graphical user interface displaying capture and redemption of anonymous payment transaction Unique QRCode, in accordance with exemplary embodiments of the present disclosure.

FIG. 10 is an exemplary graphical user interface for displaying a payment Redemption notification, in accordance with exemplary embodiments of the present disclosure.

FIG. 11 is an exemplary block diagram of server implementing one or more instruction sets, in accordance with exemplary embodiments of the present disclosure.

### DETAILED DESCRIPTION

The concept of digital cash is not new but with a creative application of existing technology and streamlined workflows the future of cash transactions can be changed forever. Barcode/QR Code Digital has identified that creative application. This revolutionary view of the how to apply the tools of digital currency will save time, money, effort and improve convenience while earning a per transaction fee for providing a much needed service, access to our end users cash on their terms.

Most tipping etiquette guides say that “You are not dressed if you don't have cash.” The disclosure aims to turn this belief about hard cash on its head because mobile devices can access financial accounts, associated with a user of the mobile devices, via one or more networks (private or public), and allow the user to transfer funds between the account associated with the user to another financial account. The financial account that receives the transferred funds could be associated with another user of one or more other mobile devices, or another account associated with the user. By extension this can also be applied to other ways of transferring money from one user to another. For example, a dollar amount associated with a winning lottery ticket can be transferred from one user's account to another account using the systems and methods disclosed herein. For instance, the user can use one of the mobile devices to scan the winning lottery ticket and an amount associated with the total amount of the winning lottery ticket can be transferred from the account associated with the user to another account. The amount can be the total monetary value of the winning lottery ticket, or it can be some fraction of the total monetary value of the winning lottery ticket. The total monetary value is associated with a unique transaction, and the transaction can be initiated after the winning lottery ticket is redeemed with a redemption partner. In some embodiments, the winning lottery ticket can be redeemed via the one or more networks, or can be redeemed at participating lottery ticket redemption partner (e.g., a store front).

Another aspect of the instant disclosure, is that once an amount is received in a user's account, the value of the amount never expires. The value can be a number associated with the QR code that reflects the monetary of the amount.

A unique Barcode/QR code is generated with encrypted account information that can be captured by any camera for a one-time redemption. The payee's mobile device (user whose account will receive an amount of money associated with the Barcode/QR code) can take a picture of the Barcode/QR code and the value associated with the Barcode/QR code can be redeemed whenever the payee wants to redeem the value associated with the Barcode/QR code.

From tipping a valet to donating to a homeless person to paying your portion of a bill the CCD app users will always have cash and the payee will not require the CCD app, any other app or any connection to the CCD app user at all. It is a completely anonymous transaction much like a hard cash transaction.

Aside from the peer to peer transactions allowed by the CCD our point of sale software will be distributed ubiquitously to allow for hard cash redemptions and purchases at partner locations.

In some embodiments, the systems and methods disclosed herein allow a user to store money in an account that is not associated with a financial institution. More specifically, the systems disclosed herein include one or more databases, where each of the one or more databases can include an entry associated with the account of the user. The database entry can include a recordation of an amount of money that has been received in the account associated with the user. The user can generate a unique Barcode/QR code associated with any fungible amount, excluding fractions of the smallest denomination of a currency (e.g., the Barcode/QR code cannot represent a 0.5 of a cent). The unique Barcode/QR code can be associated with a timestamp in which the Barcode/QR code is generated and the amount of money recorded in the database entry. This database entry can be referred to as a vault.

In some embodiments, a check cashing and bill pay functionality can be implemented by the technology disclosed herein. For example, a payroll company that generates physical checks for employees without a bank account can transfer the check amount to a server associated with an application on the employees mobile device, and that the employees' VAULT is stored on. The server generates a unique QRCode for the amount of the pay check and sends a signal to the employee's mobile device, which will in turn cause the employees' mobile device to display the QRCode which can be redeemed at a POS terminal. The server will add the check amount to the VAULT associated with an employee, and then generate a new QRCode for the total amount of the VAULT associated with an employee.

In some embodiments, a user can pay bills using a QRCode. The QRCode can be accepted as a legitimate form of payment so that an user can e-mail QRCodes for the bills they need to pay. In some embodiments, companies can create forms that can have a QRCode added as attachments to accept payments.

For users that have an account associated with a financial institution (checking or credit account), and have linked the account associated with the financial institution with an account associated with their corresponding vault, the user's mobile device can display one or more icons including a “Home” page icon and a “Generate Code Cash” icon. After the user's mobile device receives an input corresponding to the “Home” page icon or the “Generate Code Cash” icon the user's device can generate and display a sign in page, or a sign up page depending on whether the user's device (e.g., mobile phone number associated with the user's device, a super user identity associated with the device, or a subscriber identify module (SIM)) is registered with an application running on the mobile device associated with the vault. The mobile device can receive a username and password input from the user or biometrics associated with the user to access the application.

The user's mobile device can display a “Sign up” icon. After the “Sign up” icon is activated, the user's device can display one or more fields where the user can enter information to register the financial account or credit account with the account associated with the vault. The user's device can display a prompt to the user to create a new username and password. The account associated with the vault will connect to the financial account or credit account to determine if there is $0.01 available in the user's financial account or credit account. The account associated with the vault can receive a signal from the financial account or credit account confirming or denying that there is $0.01 in the user's financial account or there is a line of credit corresponding to the $0.01 amount in the user's credit account.

If the signal indicates that there is not $0.01 in the financial account or an amount of credit associated with the $0.01, the account associated with the vault will prevent the transfer of funds from the financial account or the credit account to the user's vault. In some embodiments, the account associated with the user's vault can display an alert on the screen indicating that there are insufficient funds to complete a transaction.

If the signal indicates that there is at least $0.01 in the financial account or an amount of credit that is at least $0.01, the account associated with the user's vault will deduct $0.01 from the user's account and transfer the $0.01 into a clearinghouse account. More specifically, a processor on a server that the account is stored on, sends a signal to a processor on a server that the financial account is stored on, to deduct the $0.01 from the financial account and transfer the amount to the account. After the amount of $0.01 is transferred to the clearinghouse account, the processor in the server associated with the account can send a signal to the mobile device instructing the processor on the mobile device to display an icon that will enable the user to input a monetary amount that the user wants to send to another account.

As an example, the mobile device may display a field corresponding to an amount of money that the user wants to send to another account. The field can read “Enter Amount”, and the mobile device can simultaneously generate a QR code corresponding to the amount being entered. In some embodiments, the QR code generated by the mobile device can be based on the amount of money entered. For instance, the QR code itself can be based on the amount entered, the time at which the mobile device receives the input, and a geographic location (e.g., Global Positioning System (GPS) coordinates) of the mobile device when the mobile device receives the input. The QR code can further be based on a random seed generated by the processor, as result of one or more processes executing on the processor. For instance, the processor can generate the placement of shapes in the QR code based on one or more applications that are being executed by the processor. Because the processor can execute instructions associated with one or more applications that are running on the mobile device, the processor's response to executing different instructions sets can mimic a random process and as a result a random seed can be generated based on this random process.

In some embodiments, a layout of the QR code can be based on one or more categories associated with the transfer of funds from the user's account to another account. For example, the QR code can include certain portions that correspond to different categories associated with payment a transaction. For instance, the mobile device can display a tipping category, in which the QR code is displayed on the mobile device and a recipient with another mobile device scans, or takes a photograph of, the QR code and the amount inputted into the “Enter Amount” field on the user's mobile device, is transferred from a clearinghouse associated with the user's vault, to a financial account associated with the recipient. The QR code associated with this transaction can include a portion of the code that includes a collection of one or more shapes comprising the QR code that identify the financial transaction as a tipping transaction.

In another instance, there can be category associated with a financial transaction that takes place at a point of sale (POS) terminal associated with a company. For example, the user's mobile device can display a QR code that is associated with a company, and can include certain portions of the qr code that includes a collection of one or more shapes comprising the QR code that identify the financial transaction in which funds are transferred from the clearinghouse to a financial account associated with the company. Further still, the QR code can include additional portions of the QR code that correspond to a specific POS terminal or location associated with the company (e.g., a standalone building). That is the QR code generated for a POS terminal can include one or more shapes in a particular location within the QR code that correspond to the company, a location associated with the company, and/or a specific POS terminal associated with the company.

After the user's mobile device receives an input corresponding to an amount of funds inputted into the “Enter Amount” field, say for instance $100.00, the mobile device may generate a “Generate Code Cash” icon on a display of the mobile device. After the amount has been inputted, the mobile device can generate an icon prompting a user to generate a QR code (e.g., “Generate Code Cash” button“), and the user's mobile device will send a signal to the server, in which the user's account is stored on, requesting that the server send a signal to a server at a financial institution hosting the user's financial account, to determine if the amount of funds inputted into the mobile device is available to be transferred to another account.

The signal sent to the server at the financial institution hosting the user's financial account, can include a request to deduct an amount associated with the inputted amount scaled by a predetermined value. For instance, in some embodiments the predetermined value can be a rate associated with the transaction, and this rate could be associated with . . . In some embodiments, the amount that is being requested for deduct can be equal to the product of the inputted amount and an integer value added to the rate associated with the transaction. As an example, if the inputted amount is $100.00, the server can send a signal requesting that $100.00*(1+transaction rate) be deducted from the user's financial account.

If the server receives a signal indicating that the amount that is being requested to be deducted is not available in the user's financial account, the server can send a message to the mobile device indicating that the transaction cannot be completed. The mobile device can in turn display the message to the user.

If the server receives a signal indicating that there is sufficient funds in the user's financial account, the server, associated with the user's financial institution, can deduct $100.00*(1+transaction rate) from the user's financial account and transfer $100.00 into the clearinghouse and and transfer (1+transaction rate) into an account associated with the system connecting the server associated with the user's account the user's financial account, and the clearinghouse.

Upon deposit from the CCD application the Clearinghouse will send the CCD application a notification to generate a QR Code for the transaction amount.

In some embodiments, the mobile device can receive an input corresponding to taking a screenshot, or screengrab, of the QR code, and can generate one or more icons each of which corresponds to a communication application that can be used by the mobile device to send the QR code to a receiving mobile device which can process the QR code to enable funds to be transferred from the financial account associated with the user (i.e., payor) to an account associated with the receiving mobile device (i.e., payee). The one or more communication applications can include a SMS application, an instant messaging application, an e-mail application, or any other messaging application that allows information to be transmitted wirelessly or via a wired connection between devices.
CodeCASHDigital Claimed Code:

The CCD user can provide the payee with the comfort of registering the CCD QRCode that the payee has been provided as “Claimed”

The Payee, can redeem the an amount of money associated with the QR code by visiting a Redemption location to redeem hard cash and/or make a purchase.

The Payee can present the QR Code at a redemption center that has a POS terminal. The POS terminal can scan the QR Code. Scanning the QR Code can deeplink into the server associated with the payor's account. The server associated with the payor's account can check to see if a unique transaction ID associated with the QR code has already been redeemed.

If the QR Code has been redeemed the server associated with the payor's account can transmit a signal to the POS terminal with instructions to the POS terminal that informs the POS terminal that the QR code has already been redeemed.

If the QR Code has not been redeemed, the server associated with the payee's account, will connect to the clearinghouse and deduct an amount associated with the QR Code, and will transfer a signal to an account hosted on a server associated with the POS terminal of the redemption center, at which point the POS terminal can produce cash for the payee or apply the amount associated with the QR Code to goods or services that the payee intends to purchase with the QR Code. After the QR code has been processed by the POS terminal, the server associated with the payee's account, can mark the QR Code as redeemed.

The server associated with the payee's account can add the QR Code to the vault associated with the payee, by opening the vault and navigating to a location on the server, associated with the payee's account, where a picture, screenshot, or screengrab of the QR Code is stored, and the payee can then select the QR code and add it to the vault. The server, associated with the payee's account, can also include one or more other QR codes, that the payee can select to add to the vault. The server associated with the payee's account can check to determine whether a unique transaction ID associated with each of the one or more QR codes have been already been redeemed, before the one or more QR codes are added to the vault.

If any of the QR Codes have already been redeemed, the server associated with the payee's account can add the amount associated with all of the unredeemed QR Codes to the total amount of in the Vault and generate a new QR Code corresponding to the new total amount in the CCD Vault. The server associated with the payee's account can send a signal to the mobile device associated with the payee to display the new total amount value of the new QR Code. The server associated with the payee's account can then mark the valid QR Codes as redeemed, because the amount associated with each of the individual QR codes are combined into the new total value, and therefore are no longer valid and can be marked redeemed. The server associated with the payee's account can then send a signal to the mobile device associated with the payee to display which QR Codes have been redeemed.

If none of the QR Codes have been redeemed, the server associated with payee's account can add the amount associated with each of the QR codes together, and add the result to the total amount in the vault, and generate a new QR Code corresponding to a new total amount stored in the Vault. The server can then send a signal to the mobile device associated with the payee to display the new total value of the value and a corresponding QR code associated with the new total value. The server associated with the payee's account can then mark the QR Codes that were valid, as redeemed.

The Payee can become a Payor without a registered financial institution by using the vault to generate a QR code associated with the total amount stored in the payor's vault. The payor's vault can display the total value associated with each of any unredeemed QR Codes that have been added to the payor's vault. The payor can generate a QR code associated with any fraction, up to the full amount in the payor's value. For example, the payor's mobile device can receive an input from the payor to generate a QR code associated with an amount inputted to the “Enter Amount” field, based on the total amount in the payor's vault. The server associated with the payor's account can void the original QR code associated with the total amount in the payor's vault, and will generate a new QR code associated with the amount that was input to the “Enter Amount” field. The server associated with the payor's account can generate a new QR Code for the new total amount remaining in the vault, after the amount associated with the input to the mobile device has been deducted from the total amount before the deduction.

In some embodiments, an amount in the vault can be transferred to a financial institution, and the transferred amount can correspond to a 16 digit credit card number that can be used for online purchases.

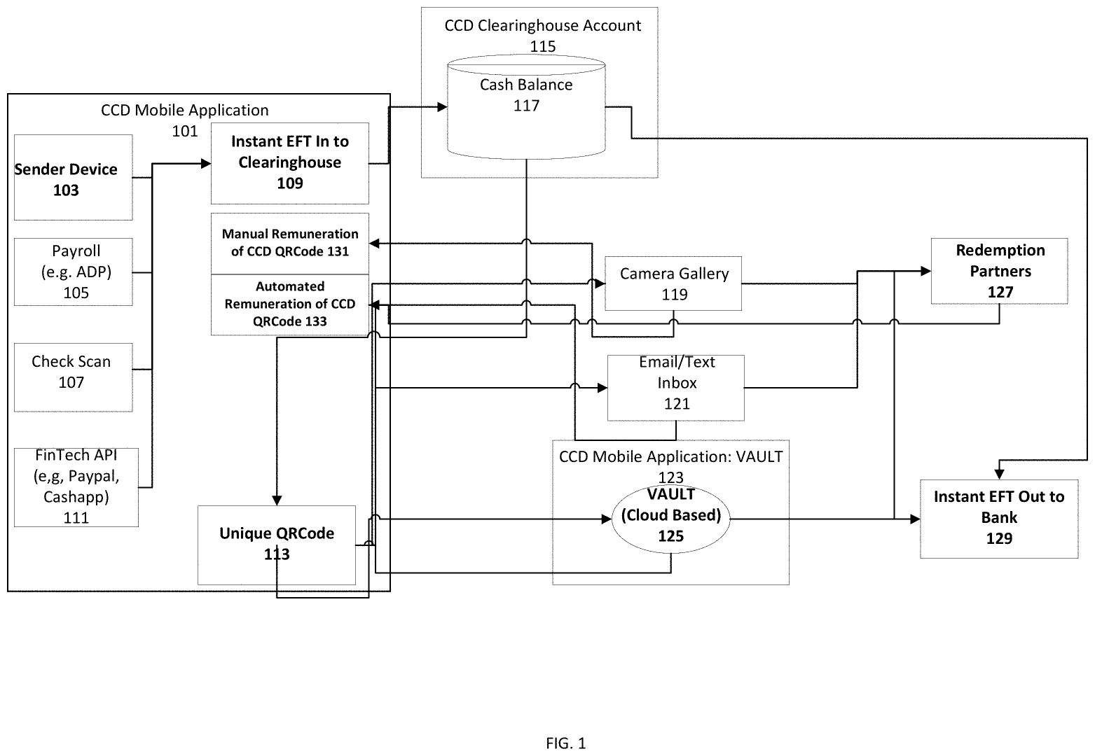

FIG. 1 is an exemplary flow diagram of an exemplary system for making anonymous payments, according to embodiments of the present disclosure. FIG. 1 illustrates the process of making anonymous payments, providing an anonymous payment, capturing an anonymous payment, and redeeming an anonymous payment. CCD Mobile Application 101 can be an application executing on a mobile phone. CCD Mobile Application 101 can include one or more subroutines executing on the mobile phone including a sender device subroutine 103, payroll subroutine 105, check scan subroutine 107, FinTech API subroutine 111, instant electronic funds transfer (EFT) clearinghouse subroutine 109, and unique QRCode generation subroutine 113.

Sender device subroutine 103 can be used to authorize the CCD Mobile Application 101 to transfer funds from an account associated with a user of the mobile device to the CCD Clearinghouse account 115, to generate a Unique CCD QRCode. Payroll 105 can be a subroutine that transfers the employees paycheck into the CCD Clearinghouse, via Instant EFT into Clearinghouse 190 in order to generate a Unique CCD QRCode. Check scan subroutine 107 can scan checks at the mobile device and transfer the scanned checks to the CCD clearinghouse account 115, via Instant EFT into Clearinghouse 109 in order to generate a unique CCD QRCode.

FinTech API subroutine 111 can be a subroutine that can integrate functionality of Fintech applications into the CCD mobile application 101. Unique QRCode generation subroutine 113 can generate a unique QRCode in response to funds being deposited into the CCD Clearinghouse Account 115. Cash balance 117 can include any cash amount electronic or otherwise in the CCD Clearinghouse Account 115. Camera Gallery 119 can be a storage location on the mobile phone that house images captured by a camera on the mobile phone. The camera on the mobile phone can be used to take images of unique QRCodes generated by the unique QRCode subroutine 113. Email/Text inbox 121 can be an email or text message application executing on the mobile phone that can be used to transfer unique QRCodes between one or more electronic devices.

CCD Mobile Application: Vault 123 can also be a subroutine that is executing on the mobile phone. The VAULT has a value in the Clearinghouse that is represented by the Unique CCD QRCode which represents the Total Amount in the VAULT. Vault (cloud based) subroutine 125 can be a subroutine that transfers funds from the VAULT to a bank account. Redemption partners 127 can be an entity that can redeem the value associated with the unique QRCode for purchase or cash. Instant EFT Out to Bank 129 can be an application that is executing on a server at a financial institution that allows the financial institution to receive funds from the account associated with the user.

On the SENDER DEVICE 103 user enters the amount for which they would like a CCD QRCode generated. Upon clicking a “Generate Code” button, the SENDER DEVICE 103 sends a signal to the server associated with CCD Mobile Application that the CCD Mobile Application is hosted on, requesting that the server send a message to the users bank requesting an account balance. The users bank responds with the balance. CCD determines if the balance is greater than the amount requested. The server confirms that the entered amount is available. The server sends a request to a server associated with the users bank to transfer the amount into CCD Clearinghouse Account 115. Using Instant EFT In to CCD Clearinghouse 109, the server associated with the user's bank instantly transfers funds into the CC Clearinghouse Account 115 increasing the cash balance 117 by the amount entered by the user. When the deposit into the CCD Clearinghouse Account 115 has been completed, a server associated with the CCD Clearinghouse Account 115 sends a confirmation that the deposit was completed back to CCD Mobile Application 101. The CCD Mobile Application 101 receives the confirmation which triggers the generation of the unique CCD QRCode 113 for the amount entered in the CCD application 101.

PAYROLL 105 can be an instruction set stored on a server associated with the user's CCD account. A payroll company transfers the user's paycheck amount into the CCD Clearinghouse Account (think direct deposit) 115 increasing the cash balance 117 of the CCD Clearinghouse Account 115 by the paycheck amount. When the deposit into the CCD Clearinghouse Account 115 has been completed, the server associated with the CCD Clearinghouse Account 115 sends a confirmation that the deposit was completed back to the CCD Mobile Application 101. The CCD Mobile Application 101 receives the confirmation from the CCD Clearinghouse Account 117 which triggers the generation of the unique CCD QRCode 113 for the paycheck amount in the CCD Mobile Application 101.

Check Scan 107 in the CCD Mobile Application 101 integrates with an existing mobile check scan service which transfers the amount of the scanned check into the Clearinghouse Account 115 increasing the cash balance 117 of the CCD Clearinghouse Account 115 by the scanned check amount. When the deposit into the CCD Clearinghouse Account 115 has been completed, the server associated with the CCD Clearinghouse Account 115 sends a confirmation that the deposit was completed back to the CCD Mobile Application 101. The CCD Clearinghouse Account 115 receives the confirmation from the CCD Clearinghouse Account 115 which triggers the generation of the unique CCD QRCode 113 for the paycheck amount in the CCD Mobile application 101.

Fintech API 111 is integrated with the CCD Mobile Application 101 to allow a

Fintech mobile application to generate CCD QRCodes by using Instant EFT In to Clearinghouse 109 into the CCD Clearinghouse Account 115. When the CCD Clearinghouse Account 115 receives a deposit it generates a unique CCD QRCode for the value entered in the Fintech mobile application.

In some embodiments, after funds have been transferred in to the CCD Clearinghouse Account 115, and the cash balance 117 has been updated, the user's mobile device, or more specifically the CCD Mobile Application 101 can cause a screen on the mobile device to display a manual remuneration of CCD QRCode 131. For instance, if there is an image of the QR code in camera gallery 119 on the user's mobile device, and the image is accessed via the CCD Mobile Application and displayed on the screen of the mobile device for redemption the manual remuneration of CCD QRCode 131 icon can be displayed on the screen. The mobile device can receive an input corresponding to the activation of the manual remuneration of CCD QRCode 131 icon from the user, after a camera associated with another user's mobile device takes a picture, or captures, the image displayed on the screen of the user's mobile device. The remuneration icon ensures that the QR code is only associated with a single transaction for a given amount of money. For example, if a user generates a QR code associated with $100.00 USD and wants to pay someone for services rendered (remuneration) by transferring funds into that person's account, after the QR code is generated and the payee's mobile device takes a picture of the QR code, the payor will click the manual remuneration of CCD QRCode 131 icon, which will cause the payor's mobile device to send a signal to the server associated with the CCD Mobile Application 101 indicating that the QR code associated with $100.00 dollars should be transferred from the vault associated with the payor's CCD Mobile Application to the vault associated with the payee's CCD Mobile Application.

Automated Remuneration of CCD QRCode 133 is an instruction set that can cause the QR code to be remunerated automatically after a user's mobile device sends the QR code to another user's mobile device using a messaging application (e.g., e-mail application on the user's mobile device, SMS application, social media messaging application, instant messaging application, or any other messaging application). For example, after the user's mobile device, and more specifically the CCD Mobile Application 101, loads a QR code into a messaging application, and sends the QR code to another user's mobile device, or CCD Mobile Application, the CCD Mobile Application 101 can send a signal to the server associated with the CCD Mobile Application 101 indicating that the QR code should be transferred from the value associated with the user's mobile device to the vault associated with the other user's mobile device.

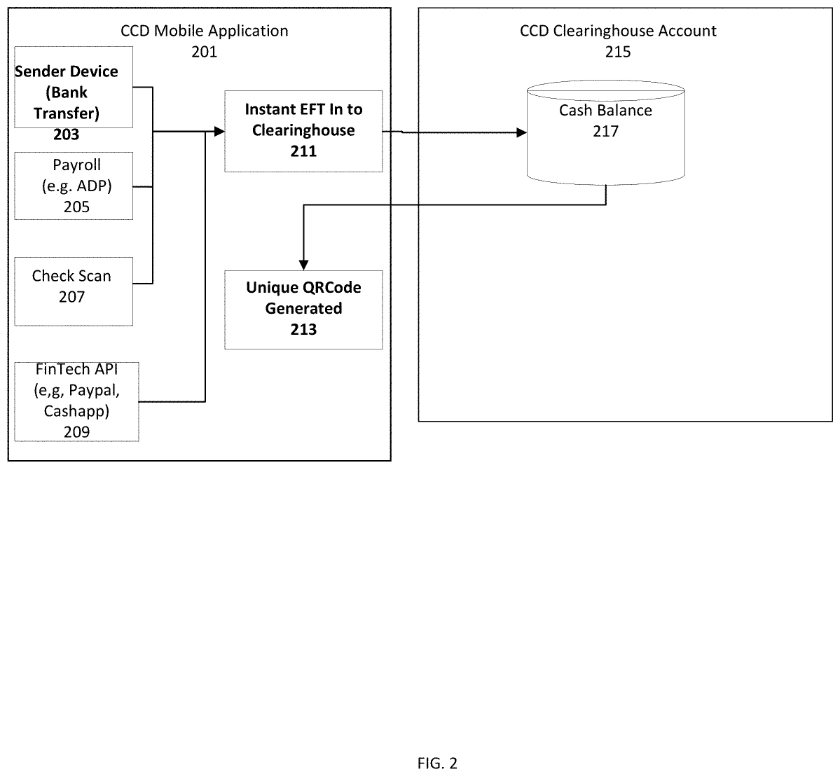

FIG. 2 is an exemplary flow diagram of an exemplary system for making anonymous payments using a unique QRCode, according to embodiments of the present disclosure. CCD Mobile Application 201 can be the same as CCD Mobile Application 101, and the subroutines in CCD Mobile Application 201 can be the same as the subroutines in CCD Mobile Application 101. CCD Clearinghouse Account 215 can be similar to CCD Clearinghouse Account 115, and the subroutines in CCD Clearinghouse Account 215 can be the same as the subroutines in CCD Clearing house Account 115.

A user can enter an amount of money that they want to pay or transfer from their bank account to another bank account, and enters it as described above. Upon clicking the “Generate QRCode” icon, the amount the user entered is instantly transferred from their bank account into the CCD Clearinghouse Account 215. More specifically, the user's mobile device, executing the client side instructions associated with the CCD Mobile Application 201, can send a signal to the server hosting the CCD Mobile Application 201, and the server can execute instruction associated with sending a request to a server associated with the user's bank account inquiring about the balance in the user's account. The server associated with the CCD Mobile Application 201 can request that the server associated with the user's bank account determine whether there is a sufficient amount (the amount that the user has entered plus a rate associated with the transaction of paying or transferring funds from the user's account to another bank account. If there are sufficient funds in the user's bank account the server associated with the CCD Mobile Application 201 can execute instructions associated with the Instant EFT In To Clearinghouse 211 that cause the server associated with the CCD Mobile Application 201 to send a signal to the

Once the amount has been successfully deposited into the Clearinghouse account the CCD application generates a Unique QRCode for the amount the CCD User entered.

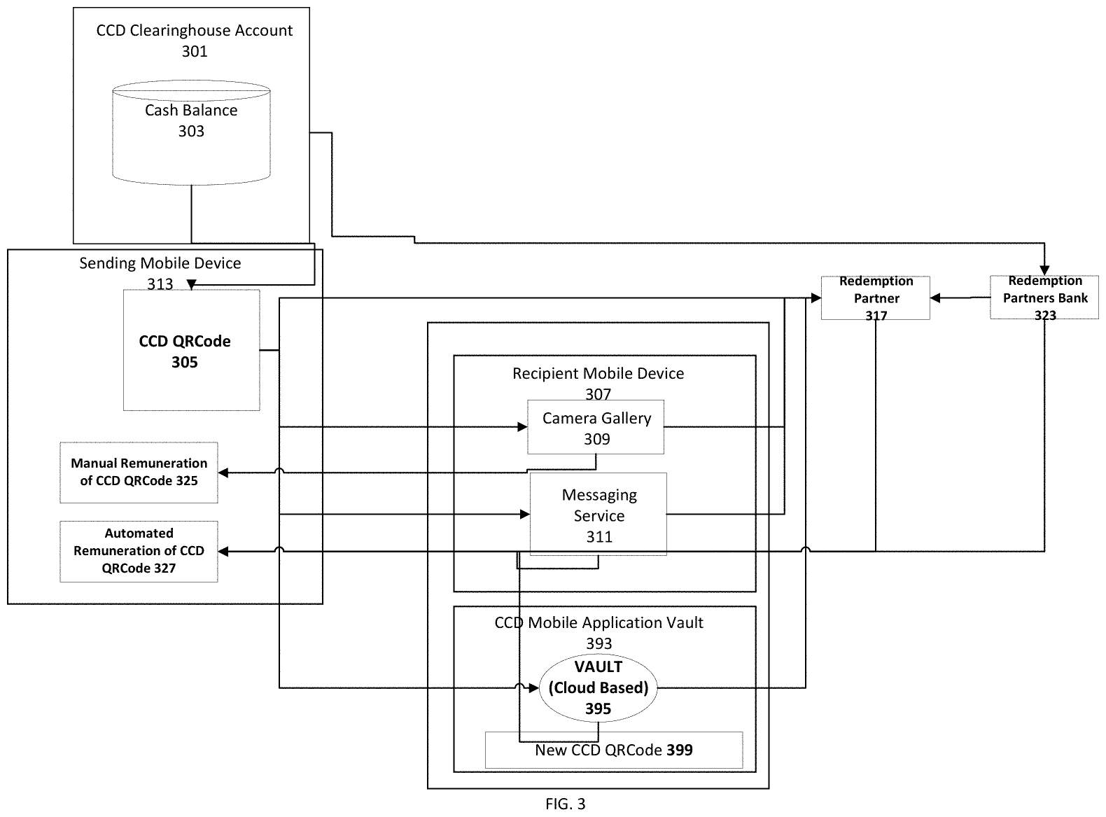

FIG. 3 is an exemplary flow diagram of an exemplary system for making anonymous payments using a unique QRCode, according to embodiments of the present disclosure. CCD Clearinghouse Account 301 can be similar to Clearinghouse Account 101. Cash Balance 303 can holds funds that are associated with CCD QRCode 305. Redemption partners 317 can be the same as redemption partners 127. CCD Mobile Application 313 can be the same as CCD Mobile Application 101. Recipient mobile phone 307 can include a camera gallery 309 that is similar to camera gallery 119, and a third party messaging inbox 311. Third party messaging inbox 311 can be an application that is a text message based messaging application or Internet based messaging application.

Recipient Mobile Device 307, can take a picture of the unique CCD QRCode 305 on a Sending Mobile Device 313 and it is stored in camera gallery 309. The Sending Mobile Device 313, and more specifically a CCD Application executing on the Sending Mobile Device 313, allows the user of the Sending Mobile Device 313 to manually acknowledge the remuneration of the CCD QRCode 305 removing it from the CCD Sending Mobile Device 313. The CCD QRCOde 305 can be remunerated by the user of the Sending Mobile Device 313 by activating an icon Manual Remuneration of CCD QRCode 325 that is displayed on the Sending Mobile Device 313.

To send the unique CCD QRCode 305 via messaging service 311 the Sending Mobile Device 313 allows the user to screenshot the image (with a unique CCD suffix that can be recognized by the VAULT) of the unique CCD QRCode 305 and select a messaging service on the Sending Mobile Device 313 to which the CCD Mobile Application on the Sending Mobile Device 313 will attach the screenshot to a message and send the message to the Recipient Mobile Device. More specifically the messaging service on the Sending Mobile Device 313 will send the message to the message service 311. The Sending Mobile Device 313 automatically acknowledges the remuneration of the Unique CCD QRCode 305 removing it from the Sending Mobile Device 313.

The CCD Mobile Application VAULT 393 scans the unique CCD QRCode 305 by accessing the devices camera lens and reading the code using QRCcode reading technology. The VAULT 395 first checks to see if the unique CCD QRCode 305 has already been redeemed. If unique CCD QRCode 305 has not been redeemed, the VAULT 395 adds the value of the unique CCD QRCode 305 to the value already in the VAULT 395 and the VAULT 395 generates a unique CCD QRCode 319 for the total value of the VAULT 315. The image of the unique CCD QRCode 113 is saved in the cloud 125. The CCD Application 313 automatically acknowledges the remuneration of the Unique CCD QRCode 305 removing it from the CCD users Sender Device.

A CCD QRCode 305 is presented to a redemption partner 317. The redemption partner 317 using a scanning device scans the CCD QRCode 305 which checks if the scanned CCD QRCode 305 has been redeemed. If the CCD QRCode 305 has not been redeemed, the Sending Mobile Device 313 will use instant electronic funds transfer functionality to transfer the amount associated with the CCD QRCode 305 from the cash balance 303 of the CCD Clearinghouse account 301 out to redemption partners bank 323. The Sending Mobile Device 313 automatically acknowledges the remuneration of the CCD QRCode 305 removing it from the Sending Mobile Device 313.

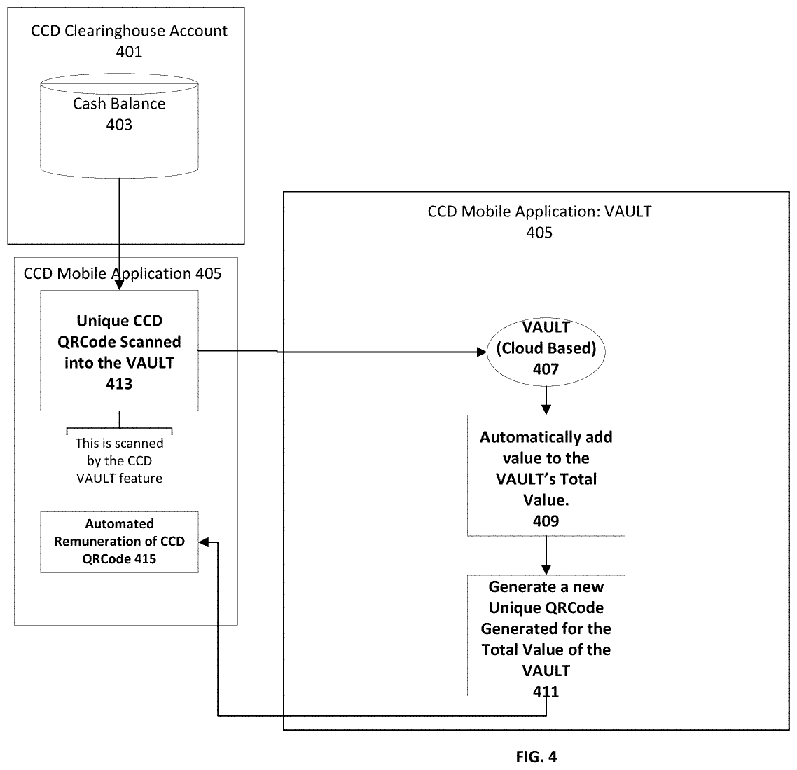

FIG. 4 is an exemplary flow diagram of an exemplary system for generating unique QRCodes, in accordance with exemplary embodiments of the present disclosure. CCD Clearninghouse Account 401 can be the same as CCD Clearninghouse Account 101, and CCD Mobile Application: VAULT 405 can be the same as CCD Mobile Application: Vault 123. Vault (Cloud Based) subroutine 407 can be similar to Vault (Cloud Based) subroutine 125. Once a unique CCD QRCode is scanned into Vault (Cloud Based) subroutine 407, the CCD Mobile Application: Vault 405 automatically adds value to the VAULT's Total Value. Then the CCD Mobile Application: Vault 405 generates a new Unique QRCode Generated for the Total Value of the VAULT.

The CCD Mobile Application VAULT 407 scans the unique CCD QRCode 413 by accessing the devices camera lens and reading the code using QRCcode reading technology. The CCD Mobile Application VAULT 407 first checks to see if the CCD QRCode 413 has already been redeemed. If CCD QRCode 413 has not been redeemed, the CCD Mobile Application VAULT 407 adds the value of the CCD QRCode 409 to the value already in the CCD Mobile Application VAULT 407 and the CCD Mobile Application VAULT 407 generates a CCD QRCode 411 for the total value of the CCD Mobile Application VAULT 407. The CCD Mobile Application 405 automatically acknowledges the remuneration of the CCD QRCode 415 removing it from the CCD users Sender Device.

The cash balance 403, in the CCD Clearinghouse Account 401, is checked by the CCD Mobile Application 405. CCD Mobile Application 405 can generate a CCD QRcode to be scanned into the VAULT 413 corresponding to an amount of money that is to be transferred from Cash Balance 403 to a bank account associated with a payee.

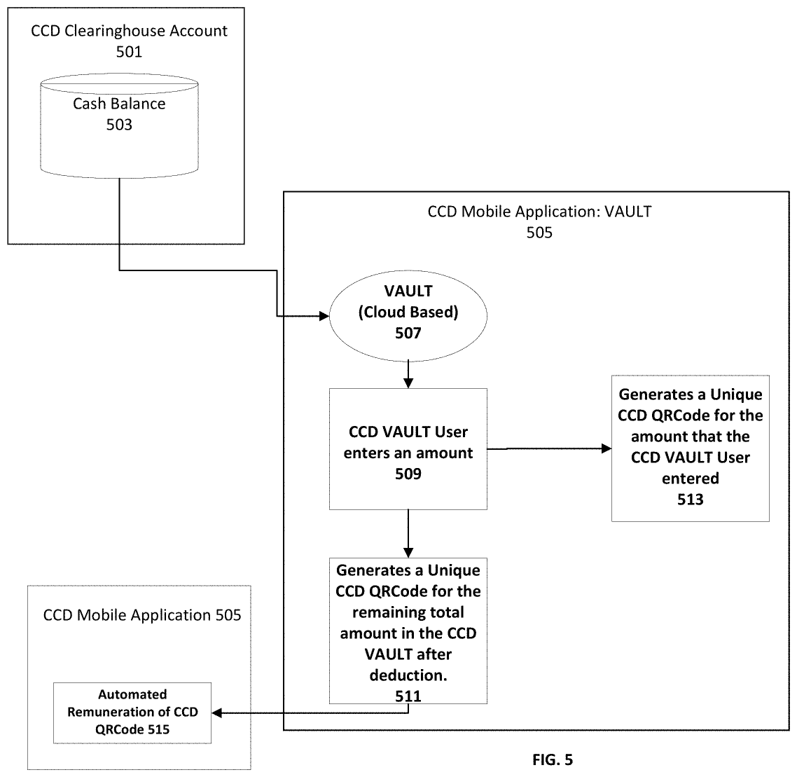

FIG. 5 is an exemplary flow diagram of an exemplary system for generating unique QRCodes, in accordance with exemplary embodiments of the present disclosure. CCD Clearninghouse Account 501 can be the same as CCD Clearninghouse Account 101. CCD Mobile Application: Vault 505 can be the same as CCD Mobile Application: Vault 123. CCD Mobile Application: Vault 505 can receive an input from a user corresponding to an amount of money that the user wants to transfer to another recipient. In response, CCD Mobile Application: Vault 505 Generates a Unique CCD QRCode for the remaining total amount in the CCD VAULT after deduction, and Generates a Unique CCD QRCode for the amount that the CCD VAULT User entered.

A user can enter the amount they want to use to pay for a service rendered, or an item, or simply to be transfer between accounts, by having CCD Mobile Application: VAULT 505 create a CCD QRCode 513 corresponding to the amount. The CCD Mobile Application: VAULT 505 deducts the amount 509 from the total value of the CCD VAULT 505 and generates a unique CCD QRCode 513 for the value entered by the user 513 and the CCD VAULT 505 generates a unique CCD QRCode 511 for the value remaining in the CCD VAULT 505 after the deduction. The CCD Application 505 automatically acknowledges the remuneration of the Unique CCD QRCode 515 removing it from the CCD users Sender Device.

The cash balance 503, in the CCD Clearinghouse Account 501, is checked by the VAULT 507. VAULT 507 can generate a CCD QRcode 513.

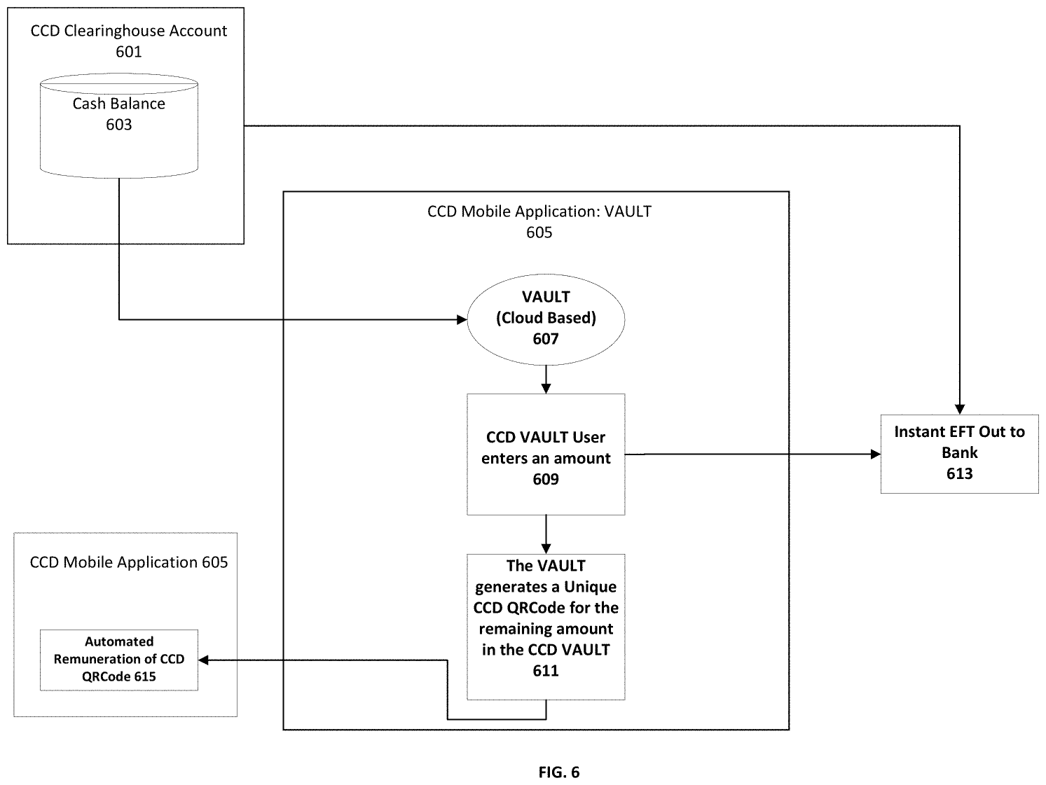

FIG. 6 is an exemplary flow diagram of transferring a unique QRCode from a cloud storage device to a bank account, in accordance with exemplary embodiments of the present disclosure. CCD Clearninghouse Account 601 can be the same as CCD Clearninghouse Account 101. CCD Mobile Application: Vault 605 can be the same as CCD Mobile Application: Vault 123. CCD Mobile Application: Vault 605 can receive an input from a user corresponding to an amount of money that the user wants to transfer to another recipient. In response, CCD Mobile Application: Vault 605 Generates a Unique CCD QRCode for the remaining total amount in the CCD VAULT after deduction and the mobile device on which CCD Mobile Application: Vault 605 is executing can transfer the funds to the Instant EFT Out to Bank 613. Instant EFT Out to Bank 613 can be similar to Instant EFT Out to Bank 129.

A user can enters the amount to transfer 609 from the CCD application: VAULT 605 out to their bank account. The CCD Mobile Application VAULT 605 deducts the amount 609 entered by the user from the total value of the CCD Mobile Application VAULT 605 and generates a unique CCD QRCode 611 for the value remaining in the CCD Mobile Application VAULT 605 after the deduction. The CCD Mobile Application VAULT 605 uses instant EFT functionality 613 to transfer the amount entered by the amount 609 from the Cash Balance 603 of the CCD Clearinghouse account 601 into the bank account 613 of the user. The CCD Mobile Application VAULT 605 automatically acknowledges the remuneration of the Unique CCD QRCode 615 removing it from the CCD users Sender Device.

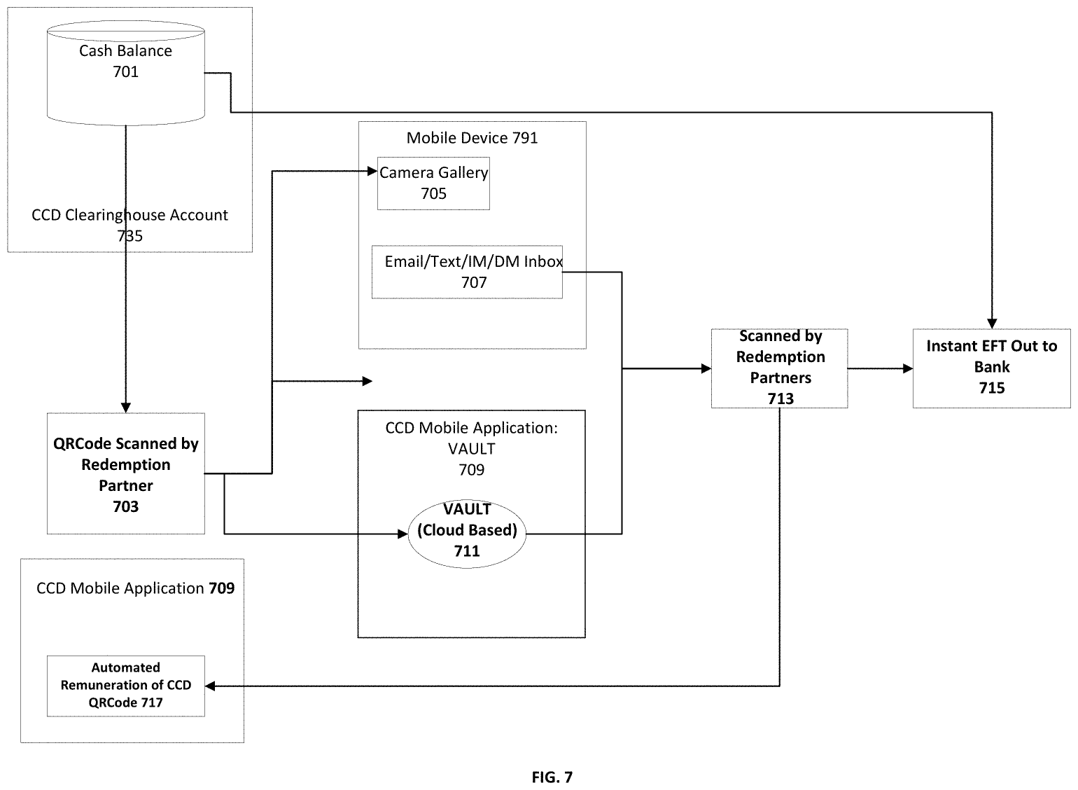

FIG. 7 is an exemplary flow diagram of a unique QRCode being scanned by a scanning device, in accordance with exemplary embodiments of the present disclosure. CCD Clearinghouse Account 735 can be the same as CCD Clearninghouse Account 101. The amount of funds available in a user cash balance 701 is tied to the unique QRCode that can be scanned by a redemption partner 703. The redemption partner 703 can scan a unique QRCode that is displayed in the camera gallery 705 on a recipients mobile device 791. The unique CCD QRCode can be stored in the recipients mobile device storage. Email/Text/IM/DM Inbox 707 can store the unique CCD QRCode as well. Once the unique QRCode is scanned by a redemption partner funds from the CCD clearinghouse account 735 to the redemption partners back via instant EFT Out to Bank 715.

A CCD QRCode 703 can be presented to a redemption partner in the form of an image scanned by the redemption partner 713. The QRCode 703 can be presented to the redemption partner via a display on the presenting user's mobile device, and the redemption partner can take a picture of QRCode 703 and it can be stored in the redemption partner's camera gallery 705. In some embodiments, the presenting user's device can send the image of the QRCode 703 to a redemption partner's device via e-mail/text/IM/DM inbox 707. In other embodiments, the QRCode 703 can be ingested in CCD Mobile Application; VAULT 709. If the QRCode 713 has not been redeemed, the CCD application executing on the presenting user's mobile device can use instant electronic funds transfer functionality 715 to transfer the amount associated with the QRCode 703 from the cash balance 701 of the CCD Clearinghouse account 735 out to redemption partners bank account 715. The CCD Mobile Application 709 automatically acknowledges the remuneration (automated remuneration of CCD QRCode 717) of the QRCode 703 removing it from the presenting user's mobile device.

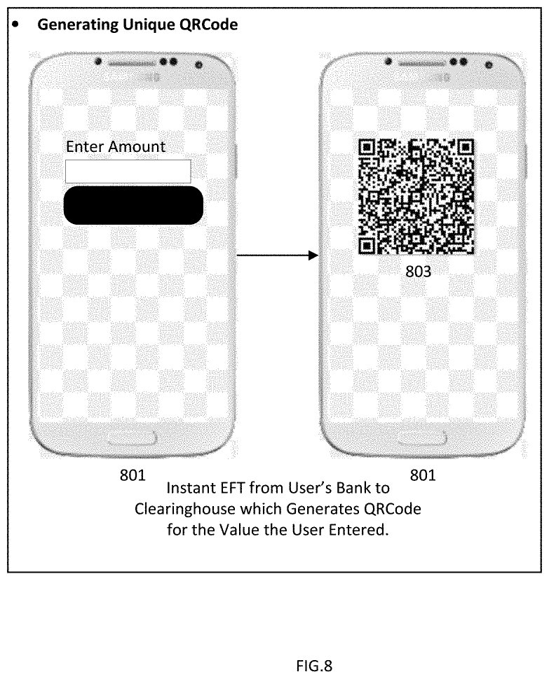

FIG. 8 is an exemplary user interface for generating anonymous payment transactions using a unique QRCode, in accordance with exemplary embodiments of the present disclosure. Mobile phone 801 can display a generate QRCode 805 icon after a user begins to enter an amount of money to be transferred from the user's bank account to a recipient's bank account. After the amount is inputted to mobile phone 801 and mobile phone 801 receives an input associated with the generate QRCOde 805 icon mobile phone 801 generates unique QRCode 803.

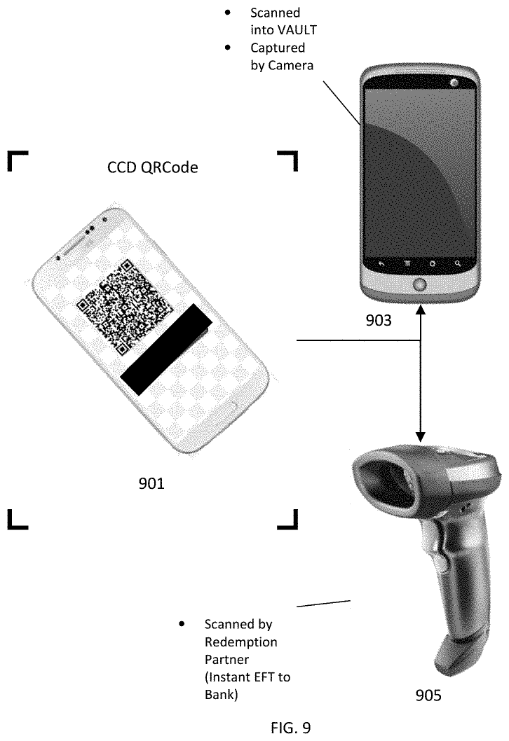

FIG. 9 is an exemplary graphical user interface displaying capture and redemption of anonymous payment transaction Unique QRCode, in accordance with exemplary embodiments of the present disclosure. In some embodiments, a user or redemption partner can scan the unique QRCode using a scanning device 905. For instance, scanning device 905, which is associated with an account of a recipient of funds, can scan the unique QRCode on mobile phone 901, and once the funds associated with the unique QRCode are transferred from a CCD Clearinghouse Account associated with the user of the mobile phone 901, a notification may be displayed on mobile phone 901 indicating that the QRCode has been redeemed. A similar notification can happen when another mobile phone 903 is used to scan the unique QRCode. When mobile phone 901 receives and input corresponding to the remunerate icon, mobile phone 901 can send a signal to the server associated with the CCD Mobile Application, where the signal indicates that the QRCode has been remunerated. The user can be manually remunerate the QRCode after another mobile device takes a picture of the QRCode or the QRCode is scanned by a scanning device. In some embodiments, the QRCode can be automatically remunerated after the QRCode is scanned.

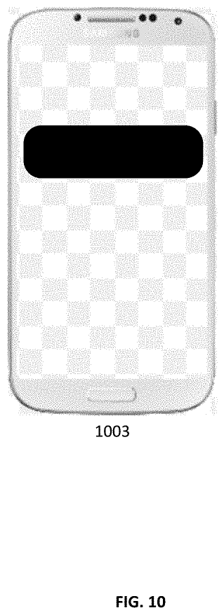

FIG. 10 is an exemplary graphical user interface for displaying a payment Redemption notification 1001, in accordance with exemplary embodiments of the present disclosure.

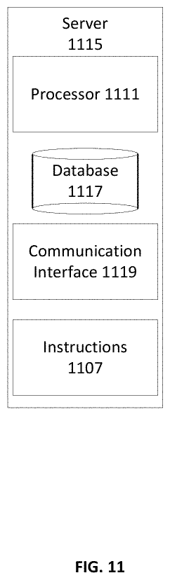

FIG. 11 is an exemplary block diagram of server implementing one or more instruction sets, in accordance with exemplary embodiments of the present disclosure. Server 1115 can include processor 1111. Processor 1111 can cause server 1115 to anonymously transfer information to a database in another server similar to server 1115.

Database 1117 can include information about one or more accounts associated with the anonymously transferred information. Communication interface 1119 can be used by server 1115 to anonymously transfer one or more messages associated with information stored in a database to another server that is similar to database 1117. Communication interface 1119 can communicate with mobile devices such as mobile phones, laptops, or even desktop computers via a communications network. The communication network can be an IEEE 802.11 network, cellular network, WiMAX network, or any other wireless network that can connect server 1115 to one or more mobile devices.

The CCD Clearinghouse Accounts disclosed can be implemented on a server with hardware as described with respect to server 1115. Instant EFT Out to Bank 129 can also be implemented on a server with hardware as described with respect to server 1115. The mobile devices described herein may include one or more processors, storage devices, one or more wireless radios, one or more speaker, one or more microphones, a screen, and one or more cameras, and one or more volume buttons.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. A non-transitory computer-readable medium storing instructions that are executable by a processing device, wherein execution of the instructions by the processing device causes the processing device to:
receive an input corresponding to an amount of funds to be transferred from a first account to a second account;
generate a code corresponding to the amount of funds to be transferred from the first account to the second account;
display the code on a screen of the processing device;
receive an indication that the funds have been transferred from the first account to the second account;
display an indication that the code has been redeemed; and
on the screen that funds have been transferred from the first account to the second account.
